(19) United States
(12) Patent Application Publication
(10) Pub. No.: US 2021/0101280 A1
(43) Pub. Date: Apr. 8, 2021

(54) TELEMETRY HARVESTING AND ANALYSIS FROM EXTENDED REALITY STREAMING

(71) Applicant: Baker Hughes Oilfield Operations, LLC, Houston, TX (US)

(72) Inventors: Jeffrey Potts, Oklahoma City, OK (US); Dustin Sharber, Oklahoma City, OK (US); John Westerheide, Edmond, OK (US)

(73) Assignee: Baker Hughes Oilfield Operations, LLC, Houston, TX (US)

(21) Appl. No.: 17/061,789

(22) Filed: Oct. 2, 2020

Related U.S. Application Data
(60) Provisional application No. 62/909,519, filed on Oct. 2, 2019.

(51) Int. Cl. B25J 9/16; G06N 3/08; G06F 3/01; G06F 3/0346; G06F 3/14

(52) U.S. Cl. CPC B25J 9/161; G06N 3/08; G06F 3/012; G05B 2219/50391; B25J 9/1694; B25J 9/1671; G06F 3/14; G06F 3/0346

(57) ABSTRACT

A method for producing an optimized instruction set for guiding a robot through a service procedure includes fitting human operators with an XR headset and controllers, instructing the human operators to perform the same service procedure through a series of individual steps, monitoring the operator's movements, and recording the XR telemetry data produced by the headset and the controllers as the operator performs the series of steps within the service procedure. The XR telemetry data is analyzed, optimized and translated into an optimized set of instructions to enable a robot to perform the service procedure. In some aspects, machine learning and neural networks are used to acquire, aggregate, analyze and optimize the XR telemetry data.

### RELATED APPLICATIONS

This application claims the benefit of U.S. Provisional Patent Application Ser. No. 62/909,519 filed Oct. 2, 2019, entitled “Telemetry Harvesting and Analysis from Extended Reality Streaming,” the disclosure of which is herein incorporated by reference.

### FIELD OF THE INVENTION

This invention relates generally to the field of robotic automation and training systems, and more particularly, but not by way of limitation, to an improved system and method for developing instructions for robotic movements and procedures.

### BACKGROUND

Modern robots are capable of performing highly complicated maneuvers and procedures that may find utility in a variety of industrial applications. Robots are commonly deployed to perform repetitive tasks in product manufacturing and assembly. For highly complicated tasks, automated robots may need to approximate the behavior of humans as closely as possible. Programming complex movements of a robot arm, for example, often relies on a technique called inverse kinematics (IK), which is based on the desired trajectory of the end effector of the robot. While path planning and collision avoidance may be possible with simpler systems, these trajectories can be difficult to define for activities with variability and requiring a high degree of dexterity or fine control.

Accordingly, there is a need for an improved system and method for programming robots to carry out complex movements. It is to this and other needs that the present disclosure is directed.

### SUMMARY OF THE INVENTION

In one aspect, the present invention provides a method for producing an optimized instruction set for guiding a robot performing a service procedure on a subject device. The method begins with the step of outfitting at least one operator with an XR headset and a controller, and connecting the XR headset and controller to a content control server with a streaming connection. The method continues with the step of providing the operator with instructions from the content control server through the headset and controllers, where the instructions require the operator to perform a series of steps within the service procedure. The method continues by monitoring the operator's movements as the operator performs the series of steps within the service procedure. In this step, the content control server records XR telemetry data produced by the headset and the controllers.

The method continues by repeating the performance of one or more of the steps in the service procedure and then aggregating the XR telemetry data recorded by the content control server. Next, the XR telemetry data is analyzed for convergence or divergence with aggregated XR telemetry data associated with each step in the service procedure. The method continues by optimizing the movements associated with each step in the service procedure using the analysis of the aggregated XR telemetry data. Once the XR telemetry data has been optimized, the method moves to the step of translating the optimized movements into a set of optimized robot instructions. The method concludes by outputting one or more optimized instruction sets configured for use in controlling the robot during the performance by the robot of the service procedure.

### BRIEF DESCRIPTIONS OF THE DRAWINGS

FIG. 1 is a depiction of operators performing a defined procedure wearing extended reality (XR) equipment.

FIG. 2 is process flow diagram for a method of developing an optimized instruction set for a robot carrying out a complex procedure.

### WRITTEN DESCRIPTION

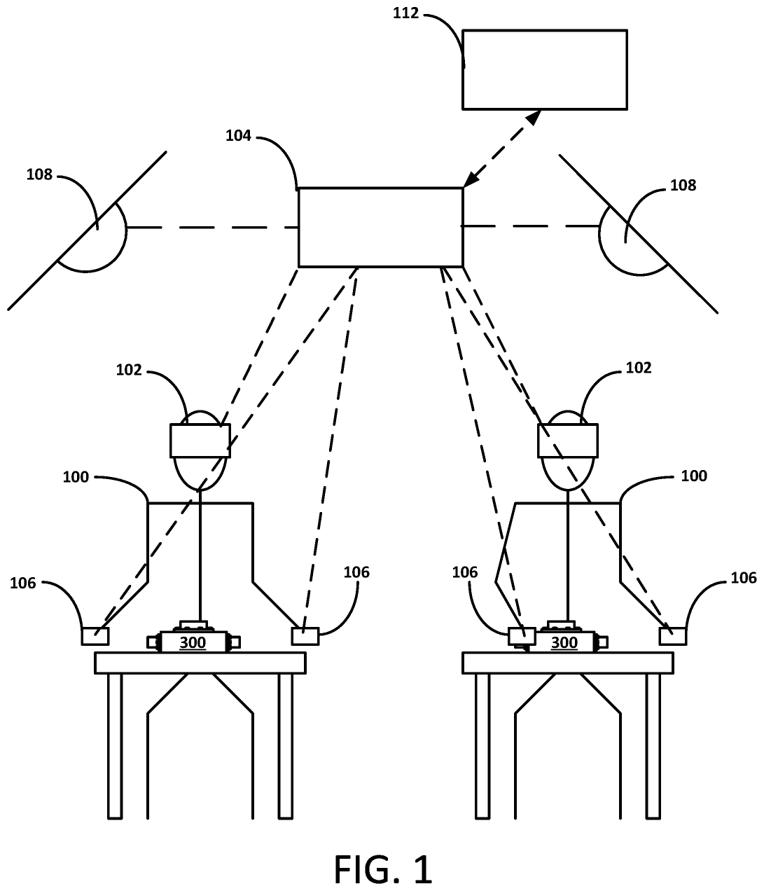

In accordance with an exemplary embodiment, FIG. 1 illustrates a pair of operators 100 engaged in carrying out a service procedure 200 on a subject device 300. Each operator 100 is wearing an enhanced or extended reality (XR) headset 102 that provides the operator 100 with visual information about the service procedure 200. The headset 102 may be a virtual reality (VR) headset, a mixed reality (MR) headset, or an augmented reality (AR) headset. As used in this disclosure, the term extended reality (XR) refers to VR, MR, AR and other enhanced visualization headsets. It will be appreciated that the headset 102 may include screens, lenses, cameras, haptic signal generators, microphones, and motion tracking sensors and emitters that detect the position and motion of the headset 102. Exemplary headsets 102 are commercially available from Microsoft Corporation under the “HoloLens” trademark or from Oculus VR under the “Rift” trademark.

Each headset 102 is configured to connect through a wired or wireless connection to a content control server 104. The content control server 104 streams content to, and receives feedback from, the headsets 102 via a data transmission protocol, such as TCP or UDP. Importantly, the communication protocol used to connect the headsets 102 to the server 104 permits multiple headsets 102 to be simultaneously connected to the server 104, with each headset 102 configured to display unique information to the operator 100. In this way, each operator 100 wearing a headset 102 will be provided a unique, independent experience while connected to a common content control server 104. In certain embodiments where there are a large number of operators 100 and headsets 102, or if the content streamed between the content control server 104 and the headsets 102 is very data intensive, multiple content control servers 104 may be used to provide content to the headsets 102.

Each operator 100 may also be provided with controllers 106 that are also connected via a streaming connection to the server 104. As depicted in FIG. 1, the controllers 106 are handheld units that are configured to monitor the position and use of the hands of the operators 100. Although a variety of controllers 106 can be integrated into this system, in some embodiments the controllers 106 are configured as a glove that measures the individual position of the hands and fingers of each operator 100. The controller 106 can also be fitted with sensors that detect grip strength as the operator 100 performs the service procedure 200 on the subject device 300.

In other embodiments, the controllers 106 are configured as a wrench, screwdriver, or other tool or instrument that is configured to measure and transmit data to the content control server 104 about the configuration, position and use of the tool or instrument by the operator 100. The headsets 102 and controllers 106 may include inertial motion units (IMUs), accelerometers, gyroscopes, proximity, optical, magnetometers, cameras and other sensors to detect, monitor and report the position, orientation and movement of the controllers 106 and headsets 102. The operators 100 may use a variety of controllers 106 while performing the service procedure 200 and that the content control server 104 is configured to track and record controller changes in real time without disrupting the streaming connections between the content control server 104, the headsets 102 and the controllers 106.

In addition to streaming content to the headsets 102, the content control server 104 also retrieves data and feedback from the headsets 102. In particular, the content control server 104 continuously records the position, orientation, motion, and images retrieved by the sensors and cameras on the headsets 102. In certain embodiments, cameras, microphones and other external sensors 108 may also be used to provide additional visual, spatial and audio information to the server 104. By connecting the headsets 102, controllers 106, and external sensors 108 to the content control server 104 with a streaming connection, the computer processing load can be borne primarily by the content control server 104. This permits the use of smaller, less expensive processors on the headsets 102, controllers 106 and sensors 108. As used herein, the term “XR telemetry tracking system 110” refers to the various collections of headsets 102, controllers 106, external sensors 108 and the content control server 104.

The service procedure 200 can be any procedure in which the operator 100 is manipulating the subject device 300. In the example depicted in FIG. 1, the subject device 300 is a small valve that can be assembled, disassembled, or otherwise serviced by the operator 100. When the service procedure 200 is initiated, the server 104 streams data to the headsets 102 worn by the operators 100. The feed from the content control server 104 may include audio, visual and haptic cues, indicators or other information that is transmitted to the operator 100 through the headset 102 and controllers 104. In some embodiments, the XR headset 102 overlays the visual information onto the subject apparatus 200 while the operator is looking at the subject device 300, while providing haptic feedback through handheld controllers 106. In this way, the headsets 102 and server 104 can cooperate to align the content feed from the server 104 as displayed through the headset 102 and as felt with the controllers 106 as the operator 100 interacts with the subject device 300.

The content control server 104 can be connected to a training module 112. The training module 112 may be configured to run on the same processors that run the content control server 104, or the training module 112 may be located on a separate computer. The training module 112 is configured to aggregate, process and analyze the data and feedback produced by headsets 102 and controllers 106, and correlate that data with the steps carried out during the repeated performance of the service procedure 200 to develop sets of optimized instructions for a robot to perform the same service procedure 200. To optimize the robot instructions, the training module 112 is provided with specific parameters, inputs, goals, targets or operational criteria that should be considered as the training module 112 produces the optimized robot instructions.

In exemplary embodiments, the training module 112 uses machine learning and neural networking functions to derive the optimized robot instructions through an iterative process in which the training module 112 analyzes the feedback and data generated by the repeated performance by one or more operators 102 of the service procedure 200. For example, the training module 112 can be provided with the physical dimensions and performance characteristics of the robot or system of robots that will be deployed to perform the service procedure 200 using the optimized instruction set. Using these inputs and the aggregated data from the headsets 102 and controllers 106, the training module 112 can produce a series of optimized robot instruction sets that are based on inverse kinematic functions to control the robot's end-effectors in accordance with the optimized steps for the service procedure 200.

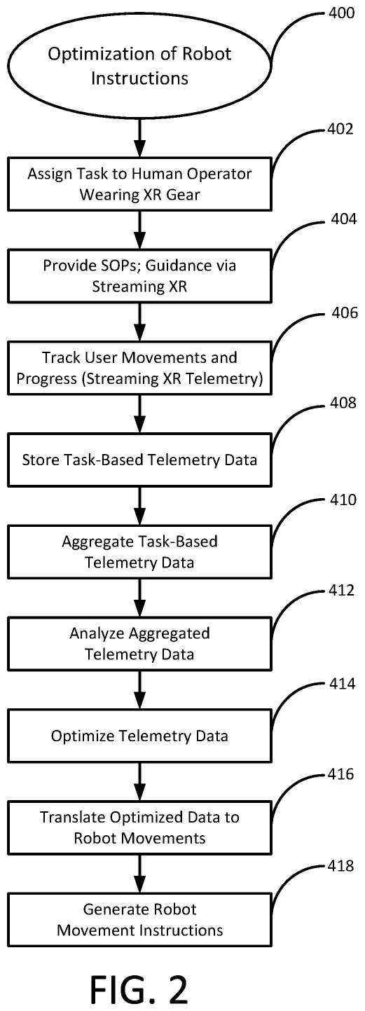

Turning to FIG. 2, shown therein is a method 400 for producing an optimized robot instruction set. At step 402, a human operator 100 is fitted with a headset 102 and controller 106, and assigned the service procedure 200 to be carried out on the subject device 300. At step 404, the content control server 104 streams to the operator 100 guidance or steps within standard operating procedures for the service procedure 200. In exemplary embodiments, the guidance is provided to a plurality of operators 100 using streaming video, audio and haptic signals through the headsets 102 and controllers 106.

At step 406, the content control server 104 records the movements of the operators 100 in response to the guidance provided to the operators 100 for the step in the service procedure 200 using streaming XR telemetry. At step 408, the XR telemetry data is stored by the content control server 104, the training module 112, or both. It will be appreciated that the method 400 repeats steps 404, 406 and 408 for the various steps in the service procedure 200. In some embodiments, the content control server 104 and training module 112 may autonomously request that the operators 100 repeat individual steps or groups of steps within the service procedure 200. For example, the supervisory systems in the content control server 104 and training module 112 may detect a divergence among the data produced by the operator 100 during a specific step within the service procedure 200. In that case, the content control server 104 may instruct the operator 100 to repeat the same step several times to obtain better convergence of the telemetry data received by the content control server 104.

At step 410, the telemetry data is aggregated and processed by one or both of the content control server 104 and the training module 112. The training module 112 analyzes the aggregated telemetry data at step 412 and produces one or more optimized instructions at step 414. Using inverse kinematic functions, the optimized instructions are translated into a series optimized robot movements at step 416. The series of optimized robot movements are consolidated into one or more optimized robot instruction sets at step 418.

It will be appreciated that the method 400 can be iterative and that the repeated performance of the service procedure 200 by a plurality of operators 100 may be useful in developing the optimized set of robot instructions. In some embodiments, the steps of aggregating, analyzing, optimizing and translating the telemetry data is performed in real time while the operators 100 are performing the service procedure 200. In other embodiments, the XR telemetry data is analyzed, optimized and used to produce the robot instruction set after the operators 100 have completed multiple iterations of the service procedure 200.

It is to be understood that even though numerous characteristics and advantages of various embodiments of the present invention have been set forth in the foregoing description, together with details of the structure and functions of various embodiments of the invention, this disclosure is illustrative only, and changes may be made in detail, especially in matters of structure and arrangement of parts within the principles of the present invention to the full extent indicated by the broad general meaning of the terms in which the appended claims are expressed.

What is claimed is:

1. A method for producing an optimized instruction set for guiding a robot performing a service procedure on a subject device, the method comprising the steps of:
outfitting at least one human operator with an XR headset and a controller;
connecting the XR headset and controller to a content control server with a streaming connection;
providing the operator with instructions from the content control server through the headset and controllers, wherein the instructions require the operator to perform a series of steps within the service procedure;
monitoring the operator's movements as the operator performs the series of steps within the service procedure, wherein the content control server records XR telemetry data produced by the headset and the controllers; and
aggregating the XR telemetry data recorded by the content control server.

2. The method of claim 1, further comprising the step of analyzing the XR telemetry data for convergence or divergence of the XR telemetry data associated with one or more steps in the service procedure.

3. The method of claim 2, further comprising the step of instructing the operator to repeat the performance of one or more of the steps in the service procedure.

4. The method of claim 3, wherein the step of instructing the operator to repeat the performance of one or more of the steps in the service procedure is carried out in response to the detection of a divergence among the data produced by the operator during one or more steps within the service procedure.

5. The method of claim 4, wherein the detection of a divergence among the data produced by the operator during one or more steps within the service procedure is made by the content control server.

6. The method of claim 5, wherein the step of repeating the performance of one or more steps in the service procedure is initiated automatically by the content control server in response to the detection by the content control server of a divergence among the data produced by the operator.

7. The method of claim 1, further comprising the step of optimizing the movements associated with each step in the service procedure using the analysis of the aggregated XR telemetry data.

8. The method of claim 7, further comprising the step of translating the optimized movements into a set of optimized robot instructions.

9. The method of claim 8, further comprising the step of outputting one or more optimized instruction sets configured for use in controlling the robot during the performance by the robot of the service procedure.

10. A method for producing an optimized instruction set for guiding a robot performing a service procedure on a subject device, the method comprising the steps of:
outfitting at least one human operator with an XR headset and a controller;
connecting the XR headset and controller to a content control server with a streaming connection;
providing the operator with instructions from the content control server through the headset and controllers, wherein the instructions require the operator to perform a series of steps within the service procedure;
monitoring the operator's movements as the operator performs the series of steps within the service procedure, wherein the content control server records XR telemetry data produced by the headset and the controllers;
aggregating the XR telemetry data recorded by the content control server;
optimizing the movements associated with each step in the service procedure using the analysis of the aggregated XR telemetry data;
translating the optimized movements into a set of optimized robot instructions; and
outputting one or more optimized instruction sets configured for use in controlling the robot during the performance by the robot of the service procedure.

11. The method of claim 10, further comprising the step of analyzing the XR telemetry data for convergence or divergence of the XR telemetry data associated with one or more steps in the service procedure.

12. The method of claim 11, further comprising the step of instructing the operator to repeat the performance of one or more of the steps in the service procedure based on a detection of a divergence among the data produced by the operator during one or more steps within the service procedure.

13. The method of claim 12, wherein the step of instructing the operator to repeat the performance of one or more steps in the service procedure is initiated automatically by the content control server in response to the detection of a divergence among the data produced by the operator.

14. A method for producing an optimized instruction set for guiding a robot performing a service procedure on a subject device, the method comprising the steps of:
outfitting at least one human operator with an XR headset;
connecting the XR headset to a content control server with a streaming connection;
providing the operator with instructions from the content control server through the headset, wherein the instructions require the operator to perform a series of steps within the service procedure;
monitoring the operator's movements as the operator performs the series of steps within the service procedure, wherein the content control server records XR telemetry data produced by the headset and the controllers; and
aggregating the XR telemetry data recorded by the content control server.

15. The method of claim 14, wherein the step of connecting the XR headset to a content control server with a streaming connection comprises connecting the XR headset to the content control server through a wireless connection.

16. The method of claim 15, wherein the step of connecting the XR headset to the content control server with a streaming connection comprises connecting the XR headset to the content control with a data transmission protocol selected from the group consisting of TCP and UDP protocols.

17. The method of claim 14, wherein the step of connecting the XR headset to a content control server with a streaming connection comprises connecting the XR headset to the content control server through a wired connection.

18. The method of claim 14, further comprising the step of optimizing the movements associated with each step in the service procedure using the analysis of the aggregated XR telemetry data.

19. The method of claim 18, further comprising the step of translating the optimized movements into a set of optimized robot instructions.

20. The method of claim 19, further comprising the step of outputting one or more optimized instruction sets configured for use in controlling the robot during the performance by the robot of the service procedure.
